(19) United States
(12) Patent Application Publication
(10) Pub. No.: US 2025/0022141 A1
(43) Pub. Date: Jan. 16, 2025

(54) INFORMATION PROCESSING METHOD AND INFORMATION PROCESSING EQUIPMENT

(71) Applicant: Woven by Toyota, Inc., Tokyo (JP)

(72) Inventor: Betty LE DEM, Tokyo (JP)

(73) Assignee: Woven by Toyota, Inc., Toyo (JP)

(21) Appl. No.: 18/768,297

(22) Filed: Jul. 10, 2024

(30) Foreign Application Priority Data
Jul. 11, 2023 (JP) 2023-113499

(51) Int. Cl. G06T 7/187; G06T 1/00; G06T 7/11

(52) U.S. Cl. CPC G06T 7/187; G06T 1/0007; G06T 7/11

(57) ABSTRACT

A computer-implemented method for combining a plurality of road graphs that partially overlap with an adjacent area, the method comprising: an acquisition step of acquiring a plurality of road graphs; a labeling step of grouping the plurality of road graphs into groups, and assigning a label to each of the road graphs in each of the groups; and a merging step of selecting one label and executing, in parallel for the groups, a process of merging a first road graph to which the selected label is assigned and a second road graph adjacent to the first road graph, wherein the merging step is repeated, with selecting a different label in each repetition, until all of the plurality of road graphs are merged.

### BACKGROUND OF THE DISCLOSURE

### Field of the Invention

The present disclosure relates to information processing methods and information processing equipment.

### Description of the Related Art

The map tiling system disclosed in the patent document 1 divides an area into sub-areas and generates a final map using names for road or rail to avoid adverse effect from the boundaries of the divided sub-areas.

### PATENT DOCUMENTS

Patent Document 1: JP2012-168961A

### SUMMARY OF DISCLOSURE

One of the aspects of the present disclosure is to provide a technique that can improve the scalability of the process of creating a road graph from images.

One of the aspects of the present disclosure is a computer-implemented method for combining a plurality of road graphs that partially overlap with an adjacent area, the method comprising: an acquisition step of acquiring a plurality of road graphs; a labeling step of grouping the plurality of road graphs into groups, and assigning a label to each of the road graphs in each of the groups; and a merging step of selecting one label and executing, in parallel for the groups, a process of merging a first road graph to which the selected label is assigned and a second road graph adjacent to the first road graph, wherein the merging step is repeated, with selecting a different label in each repetition, until all of the plurality of road graphs are merged.

According to this disclosure, the scalability of the process of creating road graphs from images can be improved.

### BRIEF DESCRIPTION OF THE DRAWINGS

FIG. 1A illustrates the configuration of a road graph generating device; FIG. 1B illustrates the process of creating a road graph from road images;

FIGS. 2A to 2C illustrate the selection process;

FIG. 3 is a flowchart illustrating the merging process;

FIGS. 4A to 4C illustrate the merging process;

FIGS. 5A and 5B illustrate the merging process; and

FIGS. 6A to 6E illustrate the merging process.

### DESCRIPTION OF THE EMBODIMENTS

Road graphs are created based on images taken of roads, such as satellite images and aerial images. However, due to computational constraints, it is necessary to create road graphs from small images, and then combine these multiple road graphs to create a road graph over a wide area. Therefore, it is necessary to merge road graphs in a precise and efficient manner.

### Overview

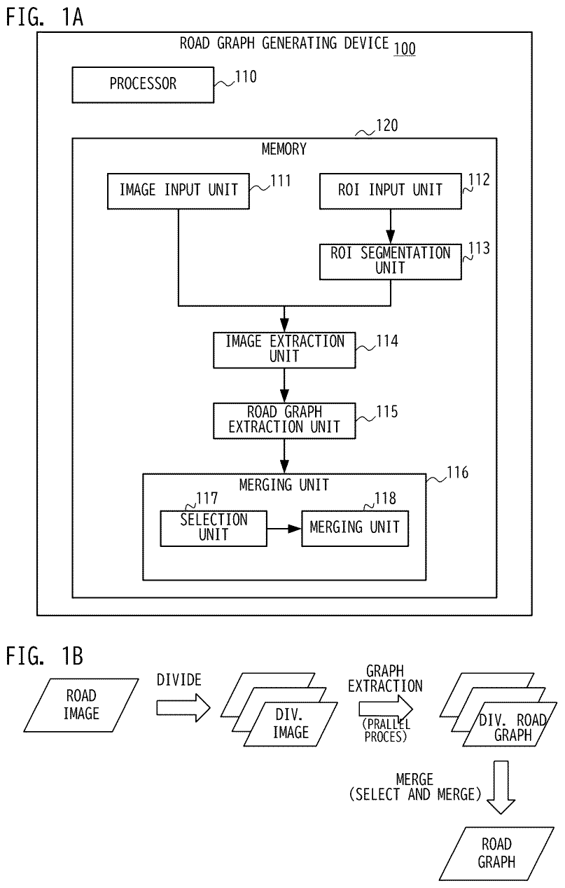

FIG. 1A shows the configuration of a road graph generating device (information processing device) 100 in one embodiment. The road graph generating device 100 has a processor 110 and a memory 120. The memory 120 non-transiently stores computer programs for causing the processor 110 to function as the image input unit 111, ROI input unit 112, ROI segmentation unit 113, image extraction unit 114, road graph extraction unit 115, and combining unit 116. The merging unit 116 has a selection unit 117 and a merging unit 118 as sub-functions.

FIG. 1B illustrates the process of creating a road graph from road images such as satellite images and aerial images. With reference to FIG. 1B, a brief description of each functional part of the road graph generator 100 is given.

Image input unit 111 acquires road images and stores them in memory 120; ROI input unit 112 accepts input of regions of interest (ROIs) for creating road graphs and passes them to ROI segmentation unit 113. The ROI segmentation unit 113 divides the region of interest into multiple sub-regions. The division is performed so that each subregion overlaps in part with the adjacent subregion. In one example, the subregions are all the same shape and size; in another example, at least one of the subregions are different in shape or size from the others. The image extraction unit 114 divides the road image acquired by the image input unit 111 into a plurality of segmented road images (hereinafter referred to simply as segmented images) according to the subregions obtained by the ROI segmentation unit 113. The number of road images to be input may be multiple, and multiple road images may be used to generate one split road image.

The road graph extraction unit 115 extracts the road graph from each segmented image. Road graph extraction can be performed using known techniques such as Sat2Graph (https://arxiv.org/abs/2007.09547), which infers a road graph from an image using graph tensor encoding. The road graph extraction process can be executed in parallel for each segmented image and is therefore scalable. A road graph consists of multiple road edges (hereinafter simply referred to as edges) and multiple intersection nodes (hereinafter simply referred to as nodes). An edge is a line segment corresponding to a plurality of points on a road. A node is an endpoint of an edge, and one node is connected to one or more edges.

The merging unit 116 merges or combines multiple segmented road graphs to create a road graph corresponding to the entire ROI. The merging process by the merging unit 116 can be viewed as a post-processing of the road graph extraction process. The merging process is performed using the selection unit 117 and the merging unit 118. The selection unit 117 determines which of the edges that overlap between road graphs should be selected as edges to be maintained when merging adjacent road graphs. The merging unit 118 uses the edges selected by the selection unit to merge adjacent road graphs. The process performed by the merging unit 116 includes a selection process by the selection unit 117 and a merging process by the merging unit 118, thus the process performed by the merging unit 116 may be referred to as merging process in a broad sense and the process performed by the merging unit 118 may be referred to as merging process in a narrow sense. The broad merging process and the merging unit 118 may be referred to as combining process and a combining unit 118, respectively, in this disclosure for the sake of distinction. The details of the merging unit 116 (selection unit 117 and merge unit 118) will be explained in more detail later.

The important points in the merging process of a segmented road map are to merge two adjacent segmented road graphs with good accuracy and to ensure scalability of the merging process for the entire road graph. To improve the merging accuracy, it is necessary to appropriately select overlapping edges and nodes in the adjacent segmented road graphs to be merged. In addition, to ensure the scalability of the overall merging process, the merging process for multiple regions must be able to be executed in parallel. This implementation improves these two points.

### Merging Process of Adjacent Road Maps

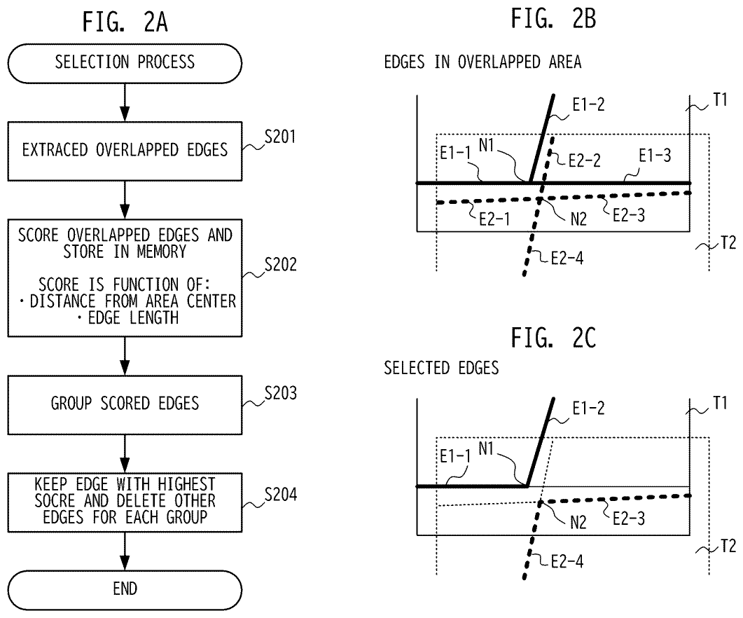

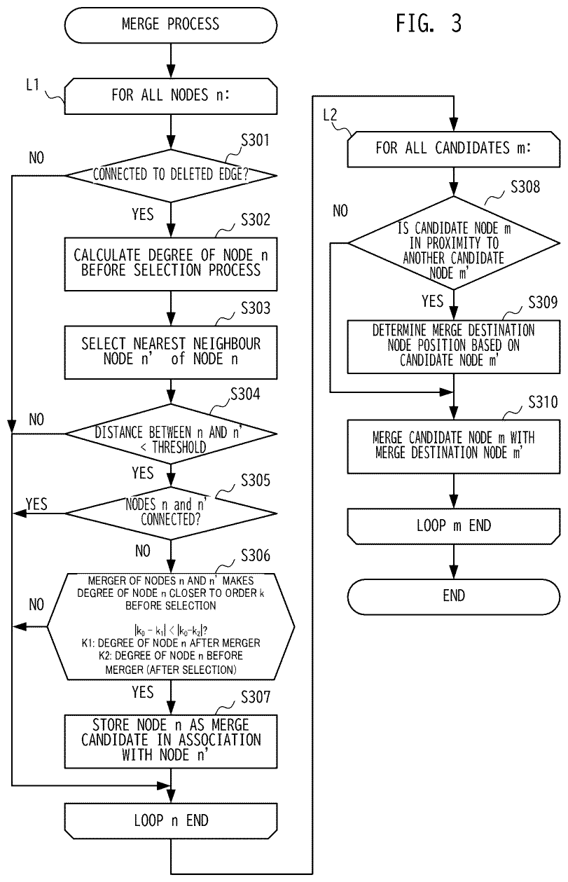

First, the process of merging two adjacent divided road graphs is explained with reference to FIGS. 2A to 2C and 3. FIG. 2A is a flowchart of the selection process performed by the selection unit 117. The selection unit 117 executes the selection process for two adjacent divided road graphs.

The following explanation uses the case of processing for the first divided road graph T1 and the second divided road graph T2 as shown in FIG. 2B as an example. Hereafter, the divided road graph T1 and the divided road graph T2 are also referred to simply as graph T1 and graph T2. For the area where graphs T1 and T2 overlap, graph T1 has edges E1-1 to E1-3 and graph T2 has edges E2-1 to E2-4.

In step S201, the selection unit 117 extracts a plurality of edges that overlap each other in the region where graphs T1 and T2 overlap. In the example in FIG. 2B, edges E1-1 and E2-1 overlap, edges E1-2 and E2-2 overlap, and edges E1-3 and E2-3 overlap. The selection unit 117 adds a buffer of a predetermined size (e.g., 5 meters) to each edge and determines that two buffered edges overlap in any of the following cases:
Multi line intersection;
Multipoint intersection;
Line crossing longer than half the length of the shorter of the two edges.

In step S202, the selection unit 117 scores the edges that are determined to overlap (hereinafter also referred to as overlapping edges) and temporarily stores them in memory. In doing so, the selection unit 117 scores each of the overlapping edges. The score is a function of the distance between the edge and the region center of the road graph and the edge length; the closer the distance from the region center, the higher the score is calculated, and the longer the edge length, the higher the score is calculated. The reason for such score calculation is that edges closer to the region center are more reliable with less influence of image distortion, and longer edges are more reliable. Edges that are determined not to overlap are stored in memory as maintained edges (edges that remain in the output merged graph).

In step 203, the selection unit 117 again groups the scored edges (in other words, the edges that are determined to overlap).

In step S204, the selection unit 117 keeps the edge with the highest score for each group and deletes the other edges.

FIG. 2C shows an example of the result of the selection process for the edges shown in FIG. 2B. Here, edge E1-1 is selected out of the edges E1-1 and E2-1 that overlap each other. Similarly, edge E1-2 is selected out of edges E1-2 and E2-2, and edge E2-3 is selected out of edges E1-3 and E2-3. Edge E2-3 is selected out of edges E1-3 and E2-3. In other words, the selection process selects edges E1-1, E1-2, and E2-3 as overlapping edges to be maintained, and edges E2-1, E2-2, and E1-3 are deleted. Edge E2-4 is also determined not to be a duplicate edge and is therefore an edge to be maintained.

FIG. 3 is a flowchart showing the merging process by the merging unit 118. The merging process is performed on the results of the selection process.

First, the “degree of node” is explained. The “degree of node” is defined as the number of edges connected to the node. For example, in FIG. 2B, node N1 has three edges E1-1, E1-2, and E1-3 connected to it, so the degree of node N1 is “3”. Similarly, in FIG. 2B, the degree of node N2 is “4”. In FIG. 2C, the degree of node N1 is changed to “2” because edge E1-3 has been deleted, and the degree of node N2 is changed to “2” because edges E2-1 and E2-2 have been deleted.

The merging process in FIG. 3 is largely composed of a loop process L1 including steps S301-S307 and a loop process L2 including steps S308-S310. Loop process L1 is performed for all nodes and determines whether or not each node is subject to the merge process (edge reconnection). Loop process L2 is the process of actually merging the nodes.

The node selected for processing in the loop process L1 is referred to as node n. In step S301, the merging unit 118 determines whether node n was connected to the edge that was deleted in the selection process. If the decision is negative, node n is not subject to the merge process, and the loop process L1 moves on to process the next node. In case of a positive judgment, the process proceeds to step S302.

In step S302, the merging unit 118 calculates the degree of node n (referred to as k₀) before the node n selection process.

In step S303, the merging unit 118 selects the nearest neighbor of node n (referred to as node n′).

In step S304, the merging unit 118 determines whether the distance between nodes n and n′ is less than the threshold value. If the distance is greater than the threshold value, node n is not subject to the merge process and the loop process L1 moves on to the next node. If the distance is less than the threshold value, the process proceeds to step S305.

In step S305, the merging unit 118 determines whether nodes n and n′ are connected. If node n is connected to the nearest node n′, node n is not subject to the merge process and the loop process L1 moves on to the next node. If it is connected, processing proceeds to step S306.

In step S306, merge unit 118 determines whether merging nodes n and n′ makes the degree of node n closer to the node degree before the selection process. In detail, the merging unit 118 determines whether or not the following conditional equation is satisfied,

ABS(k₀−k₁)<ABS(k₀−k₂).

Here, ABS is a function that returns absolute values, k₀ is the degree of node n before the selection process, k₁ is the degree of node n after the selection process, and k₂ is the degree of node n when n and n′ are merged.

If the above conditional equation is not satisfied, node n is not subject to the merge process and the loop process L1 moves on to the next node. If the above conditional equation is satisfied, processing proceeds to step S307.

In step S307, merge unit 118 stores node n in memory as a merge candidate. At this time, the merge unit 118 stores node n′ in association with node n as the merge destination of node n.

The loop process L1 is executed for all nodes.

The process of step 306 is explained in detail referring to FIGS. 2B and 2C. It is assumed that the distance between nodes N1 and N2 is less than the threshold value in step S304.

Node N2 is initially connected to edges E2-1 to E2-4, of which E2-1 and E2-2 are deleted in the selection process, and thus the degree of node N2 is “4” before the selection process and “2” after the selection process. Its distance to the nearest neighbor node N1 is less than the threshold value. The merging of node N2 and its closest node N1, which degree is “2” after the selection process, changes the degree of node N2 from “2” to “4.” In other words, the merging makes the degree of node N2 closer to the degree of node before the selection process. Therefore, node N2 is judged to merge with node N1.

Node N1 is connected to edges E1-1 to E1-3, of which E1-3 is deleted in the selection process, and thus the degree of node N1 is “3” before the selection process and “2” after the selection process. Its distance from the nearest neighbor node N2 is less than the threshold. However, the merging of node N1 and its closest node N2 changes the degree of node N1 from “2” to “4”, which does not make the degree of node closer to the degree of node before the selection process, i.e. “3”. Therefore, node N1 is not judged as a node to merge with other nodes.

The loop process L2 is executed for each candidate merge node stored in step S307. Hereafter, the candidate node to be processed in the loop process is referred to as node m.

In step S308, the existence of other candidate node m′ in proximity to candidate node m is determined. The distance threshold for this proximity determination may be the same as or different from the threshold in step S304. There may be more than one candidate node m′. If a candidate node m′ is in proximity to another candidate node m′, the process proceeds to step S309; otherwise, the process proceeds to step S310.

In step S309, the merging unit 118 determines the merge destination node position based on the candidate node m and the candidate node m′ in order to merge the candidate node m and the neighboring candidate node m′ into the same node. Examples of merge destination node positions are the position of candidate node m, the position of candidate node m′, the average position (center of gravity) of candidate node m and candidate node m′, and the weighted average position of candidate node m and candidate node m′. The weight in the weighted average can be determined based on the scores of the edges connected to the node, for example, it can be a value according to the sum or average of the scores of the edges connected to the node.

Even if there are no other candidate nodes in proximity to candidate node m, the location of the merge destination node of candidate node m may be determined as above based on candidate node m and its merge destination nodes (nodes n and n′ in step S307). Even if there are other candidate nodes in proximity to candidate node m, the location of the merge destination node may be determined in the same manner as above, taking into account the merge destination nodes of the candidate nodes.

In step S310, merge unit 118 merges the merge candidate node with its merge destination node. As an example, the merge unit 118 connects the edge connected to the merge candidate node to the merge destination node and deletes the merge candidate node.

If the decision is positive in step S308, the merge unit 118 merges the candidate nodes m and m′ with the merge destination node. The merge unit 118 may also create a new node having the merge destination node position determined in step S309 and merge the nodes m and m′ into the new node. Alternatively, merge unit 118 may change the merge destination node position of one of nodes m and m′ and merge the other nodes into the node after such a position change.

The loop process L2 is repeated until there are no more unprocessed candidate nodes m.

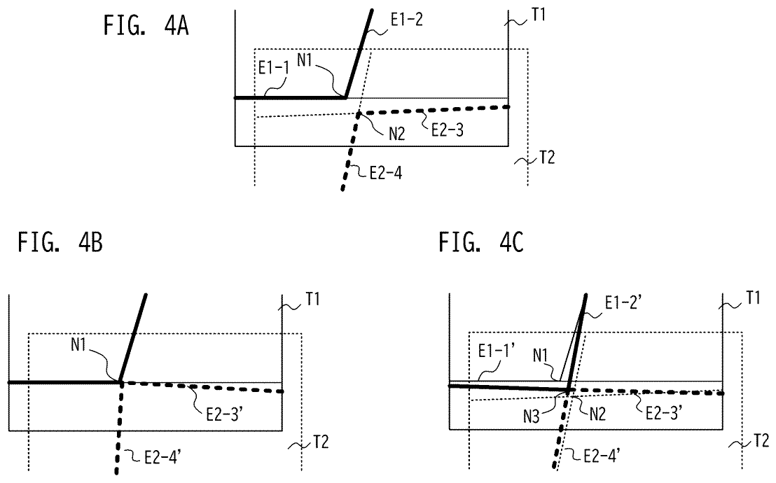

FIGS. 4A-4C are used here to illustrate the details. FIG. 4A is the reproduction of FIG. 2B.

FIG. 4B shows the result of merging of node N2 with node N1, where the merging destination node is node N1. Edges E2-3 and E2-4, which were connected to node N2 before processing, are changed to edges E2-3′ and E2-4′ connecting to node N1. Edges E1-1 and E1-2, which were connected to node N1 before processing, are not changed.

FIG. 4C shows the result of merging process of node N2 with node N1, where the merging destination node is a new node N3. Here, the position of node N3 is the average position of nodes N1 and N2, but it may be any other position. Edges E1-1 and E1-2, which were connected to node N1 before processing, are changed to edges E1-1′ and E1-1′ that connect to node N3. Similarly, edges E2-3 and E2-4, which were connected to node N2 before processing, are changed to edges E2-3′ and E2-4′ which connect to node N3.

### Parallel Processing of Road Map Merging Process

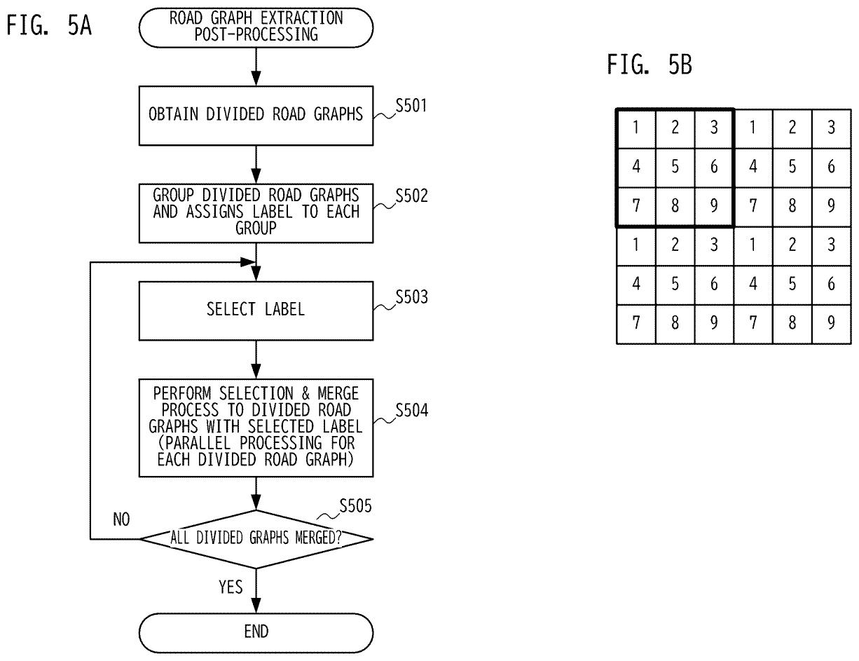

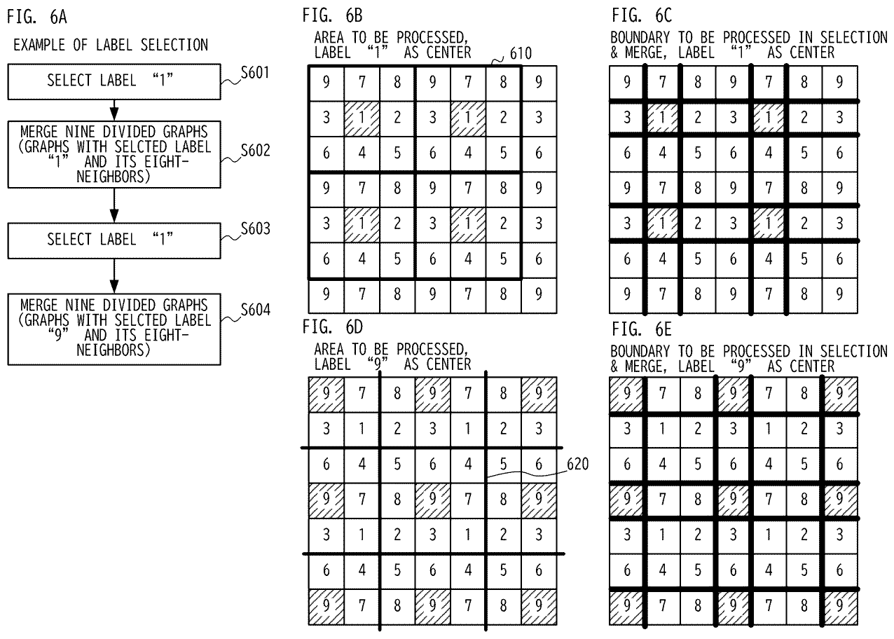

Referring to FIGS. 5A-5B and 6A-6E, we will explain how to process the aforementioned merging of adjacent road maps in parallel over the entire ROI region. The merging process of adjacent road maps can be referred to as post-processing after road graph extraction.

FIG. 5A is a flowchart of the merging process (post-processing) performed by the merging unit 116.

In step S501, the merging unit 116 obtains a plurality of divided road graphs extracted by the road graph extraction unit 115. In one embodiment, as shown in FIG. 5B, the divided road graphs have a rectangular shape, and the rectangular divided road graphs are arranged horizontally and vertically. The vertical and horizontal directions are used for convenience of explanation, and these two directions may be arbitrary and need not be orthogonal to each other.

In step S502, the merging unit 116 groups the divided road graphs and assigns a label to each of the divided road graphs in the group. In one embodiment, the merging unit 116 groups the divided road graphs so that one group includes nine 3×3 divided road graphs, as shown in FIG. 5B. The merging unit 116 also assigns labels to the divided road graphs belonging to each group according to their positions within the group. In other words, labels are assigned to the divided road graphs according to their relative positions within the group. In FIG. 5B, labels are numbers from “1” to “9,” but they need not be numbers if they can be distinguished. Labels and label assignments can also be referred to as classes and classifications, respectively.

In step S503, the merging unit 116 selects one label among a plurality of labels. In step S504, the merging unit 116 joins the divided road graphs by executing selection processing by the selection unit 117 and merging processing by the merging unit 118 on the divided road graph with the selected label and its neighbors. The merging unit 116 executes the merging process (selection and merging processes) in parallel for each group. Since the divided road graphs to be processed in the merging process differ among groups, the merging process (selection and merging processes) can be executed in parallel for each group.

In step S505, it is determined whether all divided road graphs have been merged, and if there are still unmerged divided road graphs, processing proceeds to step S503 to select another label and repeat the process. When all the split road graphs have been merged, the process is terminated.

FIGS. 6A-6E are used to provide a specific explanation of the parallel execution of the merging process. FIG. 6A shows a specific example of the loop process of steps S503-S505 in the flowchart of FIG. 5A.

In step S601, the merging unit 116 selects any label among the nine 3×3 labels. Here, it is assumed that the label “1” located in the corner among the nine labels is selected.

In step S602, the merging unit 116 performs the merging process (selection and merging processes) for the nine divided road graphs of the selected divided road graph with label “1” and its eight neighbors. Since there are a total of 12 overlapping regions in the 9 divided road graphs, the merging process for these 12 overlapping regions (boundary regions) is performed sequentially. The merging unit 116 also executes the merging process in parallel for each group.

FIG. 6B shows the divided road graphs referenced (read and updated) in each of the merging processes executed in parallel as bold rectangles. As illustrated, for each merging process, the divided road graphs to be processed are different, so each merging process can be executed in parallel simultaneously.

FIG. 6C shows the overlapping regions (boundary regions) to be combined by the merging process centered on label “1” in bold lines. As described above, the overlapping regions inside the nine divided road graphs centered on the label “1” are combined.

In step S603, the merging unit 116 selects a label different from the label “1” selected in step S601. The label selected here can be any label located at a different position in the horizontal and vertical directions from the label selected in step S601. Here, it is assumed that label “9”, which is located diagonally opposite to label “1”, is selected.

In step S604, the merging unit 116 executes the merging process (selection and merging process) in parallel for the nine segmented road graphs of the selected segmented road graph with label “9” and its eight neighbors. The merging process may be omitted for overlapping areas for which the merging process has been performed in step S602.

FIG. 6D shows the divided road graphs to be processed in each of the merging processes executed in parallel with bold rectangles 620. FIG. 6E also shows the overlapping area (boundary area) to be combined by the merging process centered on label “9” in bold lines.

As can be seen from FIGS. 6C and 6E, the entire divided road graph can be merged by performing the merging process for labels “1” and “9” (or the two divided road graphs located at opposite corners of a 3×3 divided road graph).

In the above explanation, the merging process is performed for labels “1” and “9,” but the entire graph can be merged by performing the merging process for two labels: label “1” and any one of labels “5,” “6,” “8,” and “9. In other words, the merging process can be performed for any one of the nine 3×3 segmented road graphs and another label whose position in both the vertical and horizontal directions is different from this label.

### Variant 1 of the Merging Process

Although the entire interior of the nine divided road graphs is subject to the merging process, only the overlap area between the selected label and its four neighboring divided road graphs may be subject to the merging process. In this case, select the labels “1,” “3,” “5,” “7,” and “9” and perform the join process five times to join the entire graph.

### Variant 2 of the Combining Process

More generally, the size of the group may be arbitrary, e.g., it may be 2×2 or 4×4 or larger. The vertical and horizontal sizes of the groups may also be different. That is, the size of the group may be p×q (p and q are both integers with p≥2, q≥2).

The merging unit 116 may combine multiple road graphs that are aligned in the first and second directions and partially overlap with adjacent regions by parallel execution as follows. The merging unit 116 first groups the entire plurality of road graphs in a mutually exclusive and collectively exhaustive (MECE) manner (see region 610 in FIG. 6B). Here, each group has the same shape, which all contain p×q (p≥2, q≥2) road graphs. Then, the merging unit 116 performs a merging process that combines the entire plurality of road graphs in the first group. Here, the merging process is executed in parallel on a group-by-group basis. Next, the merging unit 116 performs a second grouping of the entire plurality of road graphs in a mutually exclusive and collectively exhaustive (MECE) manner (see area 620 in FIG. 6D). The second grouping has different group boundary positions in each of the first and second directions compared to the first grouping. The merging unit 116 then performs a merging process that combines the entire plurality of road graphs in the second grouping. In general, the merging process for the two groups in this manner enables the merging of the entire plurality of road graphs. The processes can be executed in parallel.

### Advantageous Effect of Embodiment

According to the above embodiment, road graphs can be created from a wide area of road images by parallel execution of road graph extraction and merging processes. Since parallel processing is possible, road graphs over a wider area can be created by investing computational resources without increasing the overall processing time. In addition, according to the selection and merging processes of the above embodiments, the merging of two road graphs can be performed quickly and accurately.

### Other Embodiments

The above embodiments are examples only, and the present disclosure may be modified and implemented as appropriate without departing from the gist thereof.

The present disclosure can also be realized by supplying a computer program implementing the functions described in the above embodiments to a computer, and having one or more processors of said computer read and execute the program. Such a computer program may be provided to the computer by a non-transitory computer-readable storage medium that can be connected to the system bus of the computer, or may be provided to the computer via a network. The non-transitory computer-readable storage medium may be, for example, any type of disk, such as magnetic disks (floppy (registered trademark) disks, hard disk drives (HDD), etc.), optical disks (CD-ROM, DVD disks, Blu-ray disks, etc.), read-only memory (ROM), random access memory (RAM), EPROM, EEPROM, magnetic cards, flash memory, optical cards, and any type of media suitable for storing electronic instructions.

What is claimed is:

1. A computer-implemented method for combining a plurality of road graphs that partially overlap with an adjacent area, the method comprising:
an acquisition step of acquiring a plurality of road graphs;
a labeling step of grouping the plurality of road graphs into groups, and assigning a label to each of the road graphs in each of the groups; and
a merging step of selecting one label and executing, in parallel for the groups, a process of merging a first road graph to which the selected label is assigned and a second road graph adjacent to the first road graph,
wherein the merging step is repeated, with selecting a different label in each repetition, until all of the plurality of road graphs are merged.

2. The method according to claim 1,
wherein each of the groups contains 3×3 road graphs,
wherein the label is assigned according to a position within a group,
wherein the second graphs include eight-neighbor road graphs of the first graphs.

3. The method according to claim 2,
wherein the merging step is executed with selecting a first label corresponding to one of the 3×3 road graphs, and then the merging step is repeated with selecting a second label corresponding to a road graph whose position in both a first direction and a second direction in the group is different from that of the road graph with the first label.

4. A computer-implemented method for combining a plurality of road graphs that are aligned in a first direction and a second direction and partially overlap with an adjacent area, the method comprising:
a first merging step of performing a merging process that merges road graphs in parallel for each first group in road graph groups, the road graph groups are generated by grouping the plurality of road graphs in mutually exclusive and collectively exhaustive manner and have a same shape; and
a second merging step of performing a merging process that merges road graphs in parallel for each second group the road graph groups,
wherein the first group and the second group have a same shape, and a boundary of the first group and a boundary of the second group are different for the first direction and the second direction.

5. An information processing apparatus comprising a processor and a memory storing a computer-program which, when executed by the processor, causes the processor to perform the method of claim 1.
